(19) United States
(12) Patent Application Publication
(10) Pub. No.: US 2024/0310034 A1
(43) Pub. Date: Sep. 19, 2024

(54) HEAT PUMP INTEGRATED WITH A NUCLEAR POWER PLANT

(71) Applicant: GE-Hitachi Nuclear Energy Americas LLC, Wilmington, NC (US)

(72) Inventors: Giridhar JOTHIPRASAD, Clifton Park, NY (US); Todd JANKOWSKI, Ballston Lake, NY (US); Brian HUNT, Spring Grove, PA (US); Ya-Tien CHIU, Niskayuna, NY (US); Robert MARTIN, Ontario (CA); Ayesh SUDASINGHE, Ontario (CA)

(73) Assignee: GE-Hitachi Nuclear Energy Americas LLC, Wilmington, NC (US)

(21) Appl. No.: 18/353,207

(22) Filed: Jul. 17, 2023

Related U.S. Application Data
(60) Provisional application No. 63/389,930, filed on Jul. 17, 2022.

(51) Int. Cl. F22B 1/16; E21B 43/24; F25B 1/10; F25B 9/00; G21D 5/06; G21D 9/00

(52) U.S. Cl. CPC F22B 1/162; E21B 43/2406; F25B 1/10; F25B 9/008; G21D 5/06; G21D 9/00

(57) ABSTRACT

An integrated nuclear-powered heat pump system includes a nuclear power plant including a nuclear reactor coolant and may be configured to generate electricity. The system additionally includes a heat pump including a refrigerant as a working fluid. The heat pump is integrated with the nuclear power plant so as to be in at least thermal contact with the nuclear reactor coolant. The electricity generated by the nuclear power plant may be used to drive the heat pump. The system is instrumental with regard to generating heat for industrial applications.

### CROSS-REFERENCE TO RELATED APPLICATION

The present application claims priority under 35 U.S.C. § 119 to U.S. Provisional Application No. 63/389,930, filed Jul. 17, 2022, the entire contents of which are hereby incorporated herein by reference.

### BACKGROUND

### Field

The present disclosure relates to a heat pump integrated with a nuclear power plant. The heat pump may be configured to be driven with electricity output from the integrated nuclear power plant (or another nuclear power plant). The heat pump is configured to utilize the nuclear reactor coolant from the nuclear power plant to thermally interact with the heat pump fluid/refrigerant of the heat pump (e.g., indirect cycle) or to utilize the nuclear reactor coolant directly as a heat pump fluid/refrigerant for the heat pump (e.g., direct cycle).

### Description of Related Art

A heat pump is configured to transfer thermal energy from one location to another location. In particular, a heat pump enables heat to be transmitted from a heat source at a lower temperature to a heat sink at a higher temperature. The cycle of the heat pump may be operated in a forward direction or a reverse direction. As a result, a heat pump may be referred to as a heater if the goal is to warm the heat sink. Conversely, a heat pump may be referred to as a cooler if the goal is the cool the heat source. In either situation, heat is being moved from a colder location to a warmer location via the heat pump.

### SUMMARY

At least one embodiment relates to an integrated nuclear-powered heat pump system. In an example embodiment, the system may include a nuclear power plant including a nuclear reactor coolant and configured to generate electricity; and a heat pump including a heat pump fluid or refrigerant as a working fluid, the heat pump integrated with the nuclear power plant so as to be in at least thermal contact with the nuclear reactor coolant, and the electricity generated by the nuclear power plant may be used to drive the heat pump. Herein, the term “heat pump fluid” may be used in some instances, while the term “refrigerant” is used in other instances. It should be understood that the terms “heat pump fluid” and “refrigerant” are interchangeable and refer to the same fluid.

In an additional embodiment of the system, the nuclear power plant may be configured such that the nuclear reactor coolant is not utilized for mechanical work before coming in thermal contact with the heat pump.

In another embodiment of the system, the nuclear power plant may be configured such that the nuclear reactor coolant passes through a turbine before coming in thermal contact with the heat pump.

In another embodiment of the system, the nuclear power plant and the heat pump may be configured such that the nuclear reactor coolant thermally contacts the heat pump fluid/refrigerant in a heat exchanger (e.g., indirect cycle) prior to the heat pump fluid/refrigerant being subjected to compression (e.g., single stage or multi-stage) to achieve an increased desired temperature.

In another embodiment of the system, the nuclear power plant and the heat pump are configured such that the increased desired temperature of the refrigerant is higher than a steam temperature of the nuclear reactor coolant from the nuclear power plant.

In another embodiment of the system, the increased desired temperature of the refrigerant may be more than double the steam temperature of the nuclear reactor coolant from the nuclear power plant.

In another embodiment of the system, the heat pump may be configured such that the refrigerant is subjected to intercooling between stages of a multi-stage compression.

In another embodiment of the system, the heat pump may be configured such that the refrigerant is subjected to intercooling with a saturated vapor.

In another embodiment of the system, the heat pump may be configured such that the refrigerant is subjected to intercooling with an intercooler.

In another embodiment of the system, the heat pump may be configured such that the refrigerant is subjected to intercooling with an intercooler and a saturated vapor.

In another embodiment of the system, the heat pump may be configured such that the refrigerant with the increased desired temperature is supplied to a once-through steam generator (OTSG) to heat a process fluid for an industrial application.

In another embodiment of the system, the heat pump may be configured such that the refrigerant exiting the once-through steam generator (OTSG) is expanded to yield a saturated liquid and a saturated vapor that is separated from the saturated liquid.

In another embodiment of the system, the heat pump may be configured such that the saturated vapor is utilized for intercooling the refrigerant between stages of a multi-stage compression.

In another embodiment of the system, the refrigerant may be R-718.

In another embodiment of the system, the heat pump may be configured to operate in a closed loop cycle such that the refrigerant thermally interacts with the nuclear reactor coolant without physical intermingling (e.g., indirect cycle). With regard to “closed loop cycle,” it should be understood that the nuclear reactor coolant comes from the nuclear reactor and returns to the nuclear reactor after the heat pump.

In a further embodiment of the system, the heat pump may be configured to operate in a closed loop cycle such that the nuclear reactor coolant from the nuclear power plant is utilized as the refrigerant in the heat pump (e.g., direct cycle).

At least one embodiment relates to a method of generating heat for an industrial application. In an example embodiment, the method may include integrating a nuclear power plant with a heat pump, the nuclear power plant including a nuclear reactor coolant and configured to generate electricity, the heat pump including a refrigerant as a working fluid; leveraging a thermal energy of the nuclear reactor coolant from the nuclear power plant for the heat pump; performing a compression (e.g., single stage or multi-stage) of the refrigerant in the heat pump using electricity generated by the nuclear power plant so as to achieve an increased desired temperature for the refrigerant; and heating a process fluid for the industrial application using the refrigerant with the increased desired temperature.

In an additional embodiment, the method may further include intercooling the refrigerant between stages of a multi-stage compression.

In another embodiment of the method, the industrial application may be steam-assisted gravity drainage (SAGD).

In a further embodiment of the method, the steam-assisted gravity drainage (SAGD) may be used to extract a hydrocarbon fuel.

In a further embodiment of the method, the industrial application may be a steam process such as pulp or paper drying, hydrothermal separation in petrochemical applications, or any other industrial utilization of high temperature steam.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a schematic view of an integration of a high-efficiency heat pump with a nuclear reactor for providing process heat according to an example embodiment.

FIG. 2 is a schematic view of an example embodiment involving a heat pump working fluid in thermal contact with the nuclear reactor coolant in a heat exchanger and multi-stage vapor compression with inter-stage vapor separation.

FIG. 3 is a schematic view of another example embodiment involving a heat pump working fluid in thermal contact with the nuclear reactor coolant in a heat exchanger and multi-stage vapor compression with intercooling.

FIG. 4 is a schematic view of another example embodiment involving a heat pump working fluid in thermal contact with the nuclear reactor coolant in a heat exchanger, multi-stage vapor compression with inter-stage vapor separation, and intercooling.

FIG. 5 is a schematic view of another example embodiment involving a heat pump using the nuclear reactor coolant as a working fluid with multi-stage vapor compression and inter-stage vapor separation.

FIG. 6 is a schematic view of another example embodiment involving a heat pump using the nuclear reactor coolant as a working fluid with multi-stage vapor compression, inter-stage vapor separation, and intercooling.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives thereof. Like numbers refer to like elements throughout the description of the figures.

It should be understood that when an element or layer is referred to as being “on,” “connected to,” “coupled to,” “attached to,” “adjacent to,” “covering,” etc. another element or layer, it may be directly on, connected to, coupled to, attached to, adjacent to, covering, etc. the other element or layer or intervening elements or layers may be present. In contrast, when an element is referred to as being “directly on,” “directly connected to,” “directly coupled to,” etc. another element or layer, there are no intervening elements or layers present. Like numbers refer to like elements throughout the specification. As used herein, the term “and/or” includes any and all combinations or sub-combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements, and/or groups thereof.

When the term “same” or “identical” is used in the description of example embodiments, it should be understood that some imprecisions may exist. Thus, when one element or value is referred to as being the same as another element or value, it should be understood that the element or value is the same as the other element or value within a manufacturing or operational tolerance range.

When the terms “about” or “substantially” are used in this specification in connection with a numerical value, it is intended that the associated numerical value includes a manufacturing or operational tolerance (e.g., ±10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

The processing circuitry may be hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

In the following description, illustrative embodiments may be described with reference to acts and symbolic representations of operations (e.g., in the form of flow charts, flow diagrams, data flow diagrams, structure diagrams, block diagrams, etc.) that may be implemented as program modules or functional processes including routines, programs, objects, components, data structures, etc., that perform particular tasks or implement particular abstract data types. The operations be implemented using existing hardware in existing electronic systems, such as one or more microprocessors, Central Processing Units (CPUs), digital signal processors (DSPs), application-specific-integrated-circuits (ASICs), SoCs, field programmable gate arrays (FPGAs), computers, or the like.

One or more example embodiments may be (or include) hardware, firmware, hardware executing software, or any combination thereof. Such hardware may include one or more microprocessors, CPUs, SoCs, DSPs, ASICs, FPGAs, computers, or the like, configured as special purpose machines to perform the functions described herein as well as any other well-known functions of these elements. In at least some cases, CPUs, SoCs, DSPs, ASICs and FPGAs may generally be referred to as processing circuits, processors and/or microprocessors.

Although processes may be described with regard to sequential operations, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As may be disclosed herein, the term “storage medium”, “computer readable storage medium” or “non-transitory computer readable storage medium,” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, at least some portions of example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, processor(s), processing circuit(s), or processing unit(s) may be programmed to perform the necessary tasks, thereby being transformed into special purpose processor(s) or computer(s).

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

A nuclear reactor is used to initiate and control a nuclear chain reaction and may be employed at a nuclear power plant to generate electricity. One example of such a nuclear reactor is a boiling water reactor (BWR). In a boiling water reactor, heat is produced by nuclear fission in the core, and liquid water is used as a coolant. The heat from the core causes the liquid water to boil and convert to steam which is then directly used to drive a turbine. Afterwards, the steam is cooled in a condenser and converted back to liquid water which is then returned to the core as part of a continuous loop during the operation of the reactor. Another example of a relevant nuclear reactor is a pressurized water reactor (PWR). In a pressurized water reactor, liquid water is used as a coolant but is subject to high pressure and there is no bulk boiling. The hot water is then utilized to make steam in a steam generator. Alternatively, the hot water may be used to heat a process fluid before it enters a direct cycle heat pump or used to heat a refrigerant that is used to indirectly heat the process fluid.

According to an example embodiment, the steam from the nuclear reactor may be used in connection with or to otherwise support another industrial process. Disclosed herein is a novel method of producing higher temperature steam or other process fluids using steam outputted from a nuclear-powered reactor. Light-water cooled nuclear power reactors typically produce steam at a temperature of 523-570° F. from their reactor vessel (BWRs) or steam generator (PWRs). However, many process heat applications require the process fluid to be heated to higher temperatures and pressures higher than these reactors can provide.

Electric heaters and/or combustion of a fuel may be used to provide further heating of the process fluid beyond the temperature of the steam produced by the reactor. However, such methods require costly electricity to operate and/or fuel costs and its resultant emissions from combustion.

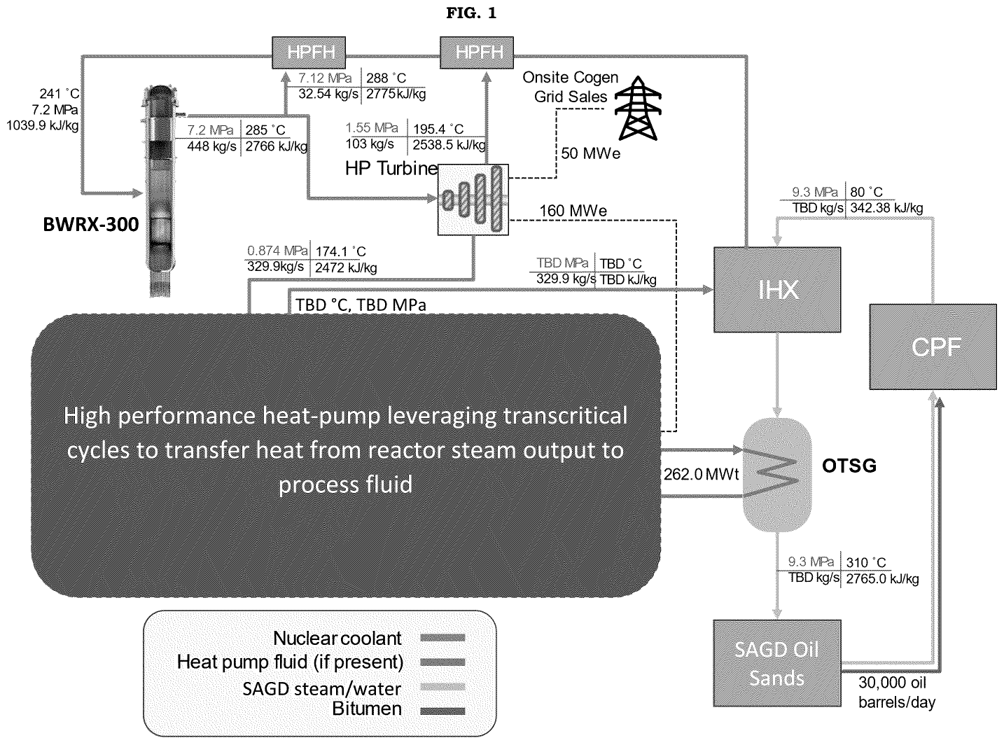

The present system transfers the heat energy left in the reactor steam output (via a heat pump), either directly or after it is first utilized for mechanical work in a steam turbine(s), to the process fluid at a higher temperature and leveraging the benefits provided by a sub-critical or trans-critical thermodynamic cycle. For example, see FIG. 1 (non-limiting example industrial application involving SAGD). A nuclear power plant integrated with a heat pump may or may not be configured to generate electricity. If the integrated nuclear power plant is configured to generate electricity, then the electricity may be used to drive the heat pump. For instance, the nuclear power plant may be configured such that the nuclear reactor coolant is utilized for mechanical work to generate electricity (e.g., to drive the heat pump) before coming in thermal contact with the heat pump. In such an instance, a minority of the nuclear reactor coolant (e.g., 20% or less, 10% or less) may be utilized for mechanical work (e.g., in a steam turbine), while a majority of the nuclear reactor coolant (e.g., 80% or more, 90% or more) may be utilized for thermal work (e.g., in a heat pump).

However, in other instances, there may be a plurality of nuclear reactors/nuclear power plants co-located with the heat pump or there may be other source of electricity (e.g., gas turbines, wind power, solar power, etc. . . . ) co-located with the heat pump. In such instances, the nuclear reactor/nuclear power plant integrated with the heat pump may be thermally connected but may not have any steam turbines and, thus, not configured to generate electricity. As a result, electricity from another co-located source may be used to drive the heat pump. At least two different example embodiments and their variants are described in the present application. Although FIG. 1 is shown in connection with steam-assisted gravity drainage (SAGD) for oil production, it should be understood that example embodiments are not limited thereto.

Integration of a heat pump (e.g., single stage or multi-stage) with a boiling water reactor (BWR) and/or a pressurized water reactor (PWR) nuclear power plant is novel. The integration improves an overall cycle efficiency of the cogeneration process (heat and electricity) by leveraging the heat in the nuclear coolant for a heat pump cycle. The alternative is to use electric heaters (that consume more electricity) and/or use natural-gas boilers (that emit CO2).

Disclosed herein is the innovative use of the nuclear-powered steam, either directly or indirectly, as R-718 refrigerant, which is 100% made up of water, in a heat pump application.

Use of a trans-critical (or subcritical), steam-based cycle for the heat pump is novel. Trans-critical cycles were carefully chosen to improve Coefficient of Performance (COP) and minimize cost of heat pump. Heat transfer occurring in the two-phase region helps increase the COP. Lastly, the choice of steam for the heat pump fluid was not obvious to those skilled in the art. Steam has the right thermodynamic properties (critical point temperature) for the desired temperature lift in the heat pump, but typically steam is not utilized in a heat pump application and typically not mechanically compressed as disclosed herein.

Use of a multi-stage, intercooled heat pump is also novel. Multi-stage compressors are needed for the temperature-lift expected in a heat pump. Further, to reduce compressor power requirements, novel approaches such as intercooling were included in the design.

Lastly, novel approaches such as use of expanders are being considered to reduce cost without compromising on efficiency. The expanders may be turbine expanders or non-turbine expanders. Each expander stage could be a turbine expander, an expansion valve, or other pressure reduction device such as a capillary tube. This single, or series of expanders, stage reduces the temperature of the heat pump fluid, thereby enabling more absorption of heat from the nuclear reactor steam during a downstream heat exchange.

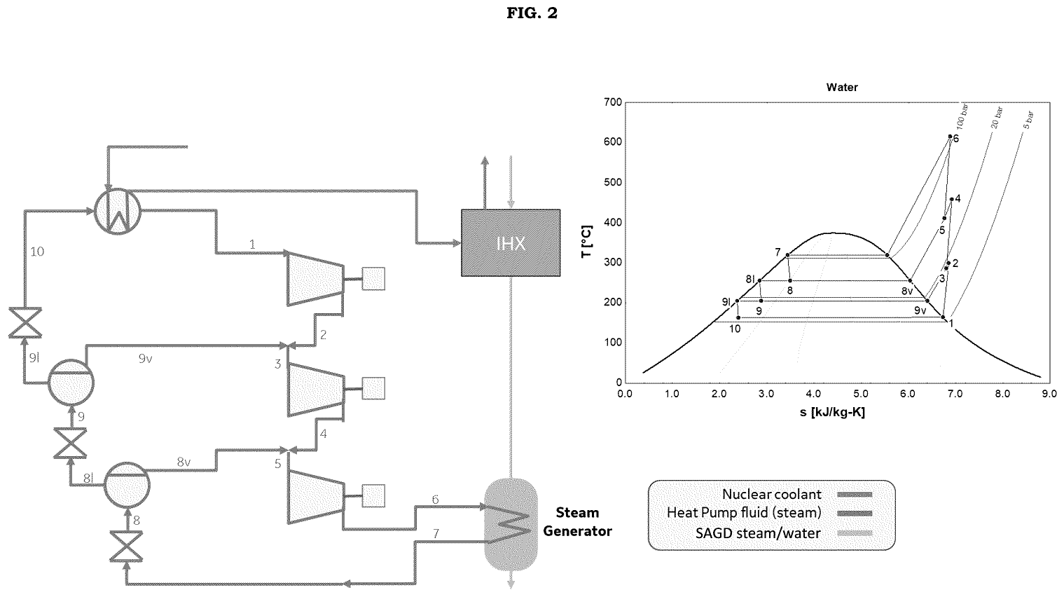

In Embodiment 1, a refrigerant R-718 in the form of two-phase steam is circulated in a closed-loop heat pump cycle. However, it should be understood that the refrigerant is not limited thereto and may include other heat pump fluids (e.g., CO2). See FIG. 2 for an example 3-stage vapor-compression heat pump with inter-stage vapor separation. Referring to FIG. 2, the refrigerant (heat pump fluid) at state 10 passes through a heat exchanger and picks up heat from the nuclear coolant (lower temperature heat-source). The heat pump fluid is heated to close to its vapor saturation-line (state 1). The heat pump fluid is then subject to compression (state 1 to 2) and may be followed by optional intercooling (state 2 to 3) using vapor 9 v separated during an expansion process. The heat pump fluid can be subjected to one stage or a series of this compression and optional vapor-based intercooling stages (if needed) until the temperature of the heat pump fluid is greater than the process fluid temperature (higher-temperature heat sink). In the example shown in FIG. 2, three stages of compression and intercooling are shown:
Heat pump Stage 1→from state 1 to state 2 (compression), then state 3 (after intercooling)
Heat pump Stage 2→from state 3 to state 4 (compression), then state 5 (after intercooling)
Heat pump Stage 3→from state 5 to state 6 (compression)

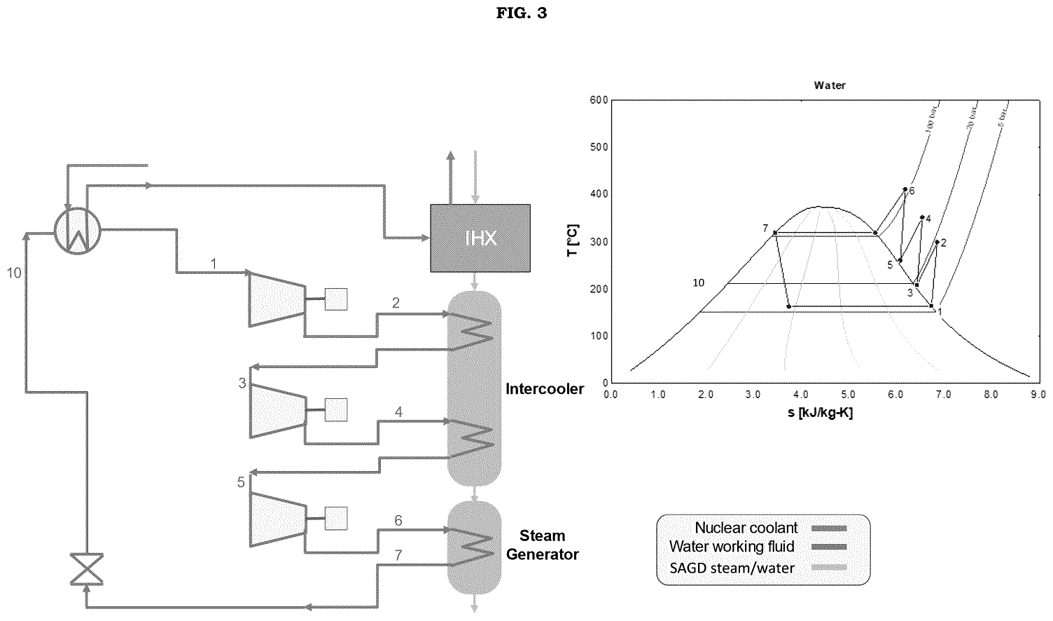

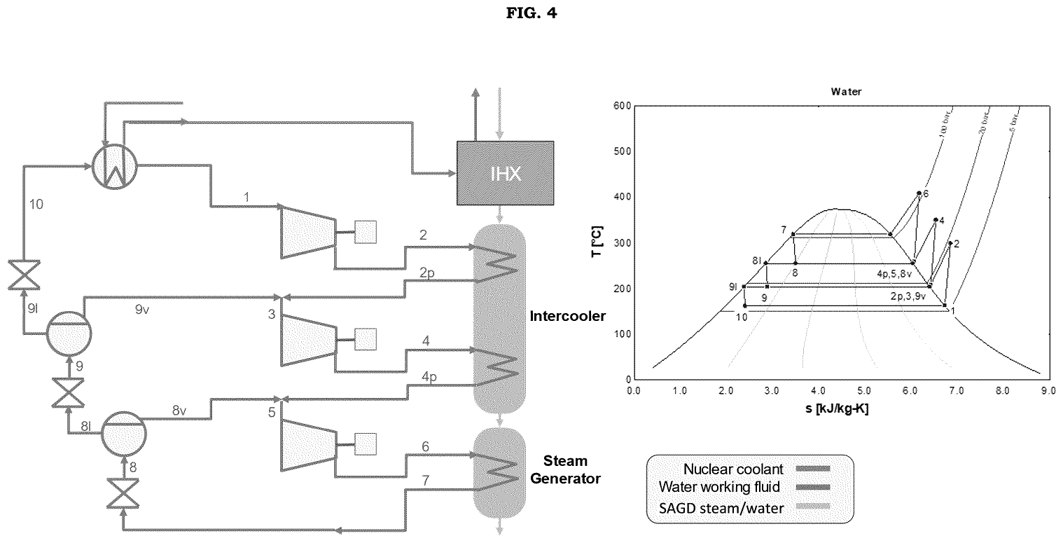

As a result, the resultant fluid is significantly hotter than the steam from the nuclear reactor and is able to be used for process heating directly or by heating another fluid. From state 6 to 7, the heat pump fluid passes through a heat exchanger providing heat to the process application (higher temperature heat-sink). An example of a process application includes utilization of the heat pump fluid in an OTSG (Once-Through Steam Generator) to heat a process fluid. Over states 7 through 10, the heat pump fluid is expanded through a series of expander stages partially or completely within the liquid-vapor dome (see T-s diagram in FIG. 2). After an expansion stage (states 8, 9 and 10), saturated vapor and saturated liquid may be separated. And the saturated vapor may be used for optional intercooling between the compression stages. The saturated liquid is subject to the following expansion stage until the lower temperature of state 10 is reached. In Embodiment 1, the optional intercooling is achieved through the saturated vapor separated after each expansion stage. In other embodiments, compression intercooling can be replaced by an intercooling heat exchanger (see FIG. 3) or supplemented by an intercooling heat exchanger (see FIG. 4) or by spraying of saturated vapor (e.g., saturated water vapor) from external sources. An intercooling heat exchanger may also be referred to as an intercooler.

Embodiment 1 and its variants improve the cycle coefficient of performance by introducing several components:
1. This embodiment may utilize a single-stage or multi-stage vapor-compressor with intercooling between one or more stages. This compressor will operate between 1,000 to 40,000 RPM at the design condition providing a pressure-ratio between 1.5 and 40. This compressor can either have a radial compressor stage or a mixed stage or an axial stage. This compressor compresses the heat pump fluid and raises it pressure and temperature.
2. An expander or a series of expanders reduces the pressure of the heat pump fluid returning from its process application and heat removal. This expander operates completely or partially within the saturated liquid-vapor dome of the heat pump fluid (see T-s diagram in FIG. 2, FIG. 3, and FIG. 4). Each expander stage could be a turbine expander, an expansion valve, or other pressure reduction device such as a capillary tube. This single, or series of expanders, stage reduces the temperature of the heat pump fluid, thereby enabling more absorption of heat from the nuclear reactor steam during state 10.
3. Various types of heat exchangers could be utilized to transfer heat from the nuclear coolant to the heat pump fluid. Suitable types include a steam-steam heat exchanger with two-phase fluids on either side of the heat exchanger.
4. Various types of heat exchangers could be utilized to transfer heat from the heat pump fluid to the process fluid. In a non-limiting embodiment, a Once-through-steam-generator (OTSG) could be utilized to heat a process steam fluid using the heat pump-fluid (steam) from the compressor exit.
5. In a variant of this embodiment, a separator to separate saturated vapor and saturated liquid is present after one or more stages of the expansion.
6. In a variant of this embodiment, a sprayer is between one or more stages of the compressor to intercool the flow between the compression stages. The sprayer may or may not be connected to the separator(s) after the expander(s).
7. In a variant of this embodiment, one or more intercooling heat exchanger(s) are utilized that transfer heat from the heat pump fluid to the process applications.

The heat pump steam boosting concept can be modified to allow for greater flexibility over a range of operating scenarios, for improved cycle efficiency and/or for larger temperature differences between the heat source (nuclear coolant steam) and heat sink (process steam) by using cycle modifications including:
Multiple heat absorption heat exchangers for accepting heat from multiple heat sources
Multiple stages of compression or multiple compressors
Multiple expanders (e.g., non-turbine and/or turbine expanders) that operate in the mixed-phase region
Multiple intercoolers between compression stages to keep the heat pump fluid close to the vapor-saturation line
A steam-driven mechanical drive turbine may be used to drive the compressor

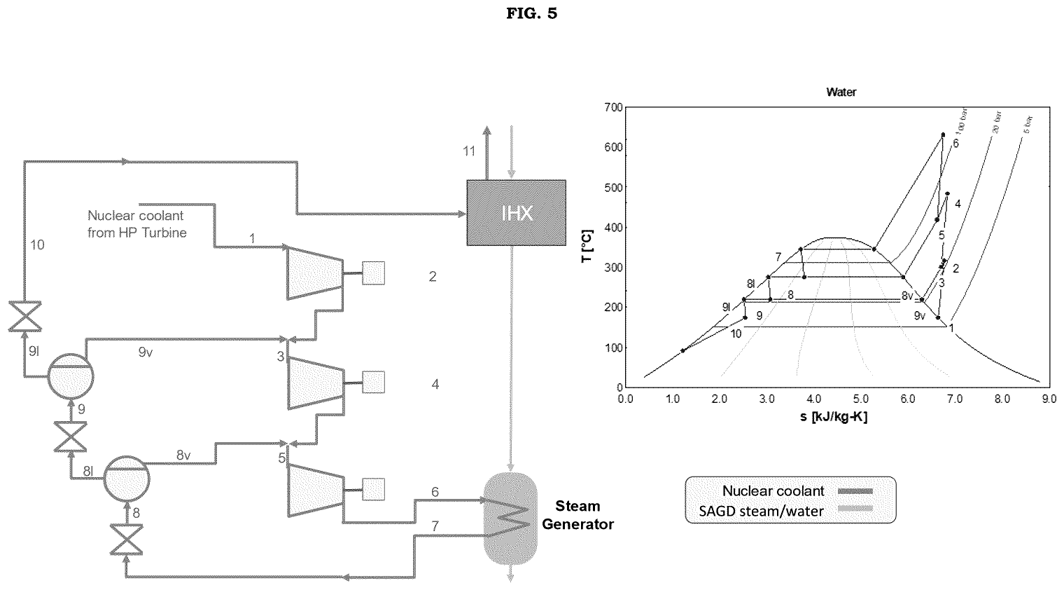

In Embodiment 2, the nuclear coolant (steam) is directly used in the heat pump cycle. See FIG. 5 for an example direct cycle with 3-stage vapor-compression heat pump and inter-stage vapor separation. The nuclear coolant fluid (steam) enters the cycle close to its vapor saturation-line (state 1). The following compression, heat exchange, and expansion processes are similar to Embodiment 1 and, hence, are only briefly described below. The heat pump fluid is then subject to compression (state 1 to 2) followed by optional intercooling (state 2 to 3) using vapor 9 v separated during an expansion process. The heat pump fluid can be subjected to one stage or a series of this compression and optional vapor-based intercooling stages (if needed) until the temperature of the heat pump fluid is greater than the process fluid temperature (higher-temperature heat sink). Consequently, the resultant fluid is significantly hotter than the steam from the nuclear reactor and is able to be used for process heating directly or by heating another fluid. From state 6 to 7, the heat pump fluid passes through a heat exchanger providing heat to the process application (higher temperature heat-sink). An example of a process application includes OTSG (Once-Through Steam Generator). Over states 7 through 10, the heat pump fluid is expanded through a series of expander stages partially or completely within the liquid-vapor dome (see T-s diagram in FIG. 2). After an expansion stage (states 8, 9 and 10), saturated vapor and saturated liquid may be separated. And the saturated vapor may be used for optional intercooling between the compression stages. The saturated liquid is subject to the following expansion stage until the lower temperature of state 10 is reached. Finally, the nuclear coolant returns to the reactor as a subcooled liquid (state 11).

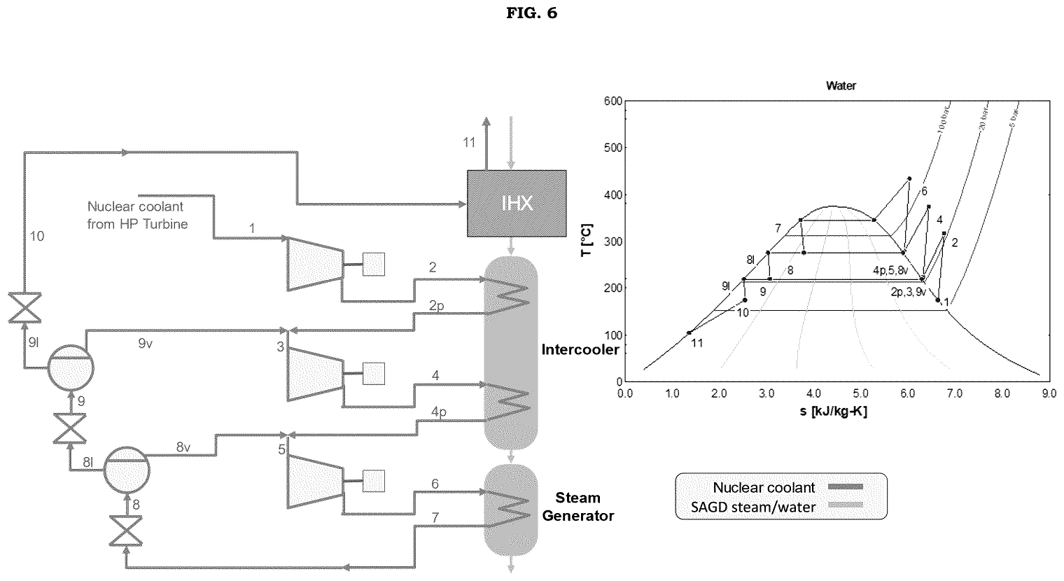

In Embodiment 2, intercooling is achieved through the saturated vapor separated after each expansion stage. In other embodiments, compression intercooling can be replaced by an intercooling heat exchanger or supplemented by an intercooling heat exchanger (see Embodiment 2″ in FIG. 6) or by spraying of saturated vapor from external sources. As previously noted, an intercooling heat exchanger may also be referred to as an intercooler.

Embodiment 2 and its variants improve the cycle coefficient of performance by introducing several components:
1. Embodiment 2 may utilize a single-stage or multi-stage vapor-compressor with optional intercooling between one or more stages. The heat pump fluid and the nuclear coolant are the same in this Embodiment 2. This compressor will operate between 1,000 to 40,000 RPM at the design condition providing a pressure-ratio between 1.5 and 40. This compressor can either have a radial compressor stage or a mixed stage or an axial stage. This compressor compresses the heat pump fluid and raises it pressure and temperature.
2. An expander or a series of expanders reduces the pressure of the heat pump fluid returning from its process application and heat removal. Again, the heat pump fluid and the nuclear coolant are the same in this Embodiment 2. This expander operates completely or partially within the saturated liquid-vapor dome of the heat pump fluid (see T-s diagram in FIG. 5 and FIG. 6). Each expander stage could be a turbine expander, an expansion valve, or other pressure reduction device such as a capillary tube. This single or series of expander stage reduce the temperature of the heat pump fluid, thereby enabling more subsequent absorption of heat.
3. Various types of heat exchangers could be utilized to transfer heat from the heat pump fluid to the process fluid. In a non-limiting embodiment, a Once-Through-Steam-Generator (OTSG) could be utilized to heat a process steam fluid using the heat pump fluid (steam) from the compressor exit.
4. In a variant of this embodiment, a separator to separate saturated vapor and saturated liquid is present after one or more stages of the expansion.
5. In a variant of this embodiment, a sprayer is between one or more stages of the compressor to intercool the flow between the compression stages. The sprayer may or may not be connected to the separator(s) after the expander(s).
6. In a variant of this embodiment, one or more intercooling heat exchanger(s) are utilized that transfer heat from the heat pump fluid to the process applications.

The heat pump steam boosting concept can be modified to allow for greater flexibility over a range of operating scenarios, for improved cycle efficiency and/or for larger temperature differences between the heat source (nuclear coolant steam) and heat sink (process steam) by using cycle modifications including:
Multiple stages of compression or multiple compressors
Multiple expanders (e.g., non-turbine and/or turbine expanders) that operate completely or partially in the mixed-phase region (i.e., the saturated liquid-vapor dome of the heat pump fluid in the T-s diagram)
Multiple intercoolers between compression stages to keep the heat pump fluid (also nuclear coolant) close to the vapor-saturation line
A steam-driven mechanical drive turbine may be used to drive the compressor

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

1. An integrated nuclear-powered heat pump system, comprising:
a nuclear power plant including a nuclear reactor coolant; and
a heat pump including a refrigerant as a working fluid, the heat pump integrated with the nuclear power plant so as to be in at least thermal contact with the nuclear reactor coolant.

2. The integrated nuclear-powered heat pump system of claim 1, wherein the nuclear power plant is configured to generate electricity for driving the heat pump such that the nuclear reactor coolant passes through one or more turbines to generate the electricity before coming in thermal contact with the heat pump.

3. The integrated nuclear-powered heat pump system of claim 1, wherein the nuclear power plant is configured such that the nuclear reactor coolant is not utilized for mechanical work before coming in thermal contact with the heat pump, and electricity from another electricity source is used to drive the heat pump.

4. The integrated nuclear-powered heat pump system of claim 1, wherein the nuclear power plant is configured such that a minor fraction of the nuclear reactor coolant is utilized for mechanical work to generate electricity, while a major fraction of the nuclear reactor coolant is utilized for thermal work in connection with the heat pump.

5. The integrated nuclear-powered heat pump system of claim 1, wherein the heat pump is configured to operate in an indirect cycle such that the refrigerant thermally interacts with the nuclear reactor coolant without physical intermingling.

6. The integrated nuclear-powered heat pump system of claim 1, wherein the heat pump is configured to operate in a direct cycle such that the nuclear reactor coolant from the nuclear power plant is utilized directly as the refrigerant in the heat pump.

7. The integrated nuclear-powered heat pump system of claim 1, wherein the nuclear power plant and the heat pump are configured such that the nuclear reactor coolant thermally contacts the refrigerant prior to the refrigerant being subjected to a multi-stage compression to achieve an increased desired temperature.

8. The integrated nuclear-powered heat pump system of claim 7, wherein the heat pump is configured such that the refrigerant is subjected to intercooling between stages of the multi-stage compression.

9. The integrated nuclear-powered heat pump system of claim 8, wherein the heat pump is configured such that the intercooling is performed with at least one of an intercooling heat exchanger or a saturated vapor.

10. The integrated nuclear-powered heat pump system of claim 7, wherein the heat pump is configured such that the refrigerant with the increased desired temperature is supplied to a once-through steam generator (OTSG) to heat a process fluid for an industrial application.

11. The integrated nuclear-powered heat pump system of claim 7, wherein the heat pump is configured such that the refrigerant with the increased desired temperature is applied to an industrial application and afterwards is expanded to yield a saturated liquid and a saturated vapor that is separated from the saturated liquid.

12. The integrated nuclear-powered heat pump system of claim 11, wherein the heat pump is configured such that the saturated vapor is utilized for intercooling the refrigerant between stages of the multi-stage compression.

13. The integrated nuclear-powered heat pump system of claim 7, wherein the heat pump is configured such that the refrigerant with the increased desired temperature is applied to an industrial application and afterwards is expanded using at least one of a turbine expander, an expansion valve, or a capillary tube.

14. The integrated nuclear-powered heat pump system of claim 1, wherein the heat pump is configured such that the refrigerant is subject to a trans-critical cycle or sub-critical cycle.

15. The integrated nuclear-powered heat pump system of claim 1, wherein the refrigerant is R-718 or carbon dioxide.

16. A method of generating heat for an industrial application, the method comprising:
integrating a nuclear power plant with a heat pump, the nuclear power plant including a nuclear reactor coolant and configured to generate electricity, the heat pump including a refrigerant as a working fluid;
leveraging a thermal energy of the nuclear reactor coolant from the nuclear power plant for the heat pump;
performing a compression of the refrigerant in the heat pump using electricity generated by the nuclear power plant so as to achieve an increased desired temperature for the refrigerant; and
heating a process fluid for the industrial application using the refrigerant with the increased desired temperature.

17. The method of claim 16, wherein the integrating includes the heat pump being configured to operate in a direct cycle such that the nuclear reactor coolant from the nuclear power plant is utilized directly as the refrigerant in the heat pump.

18. The method of claim 16, wherein the compression is a multi-stage compression, and the method further comprises:
intercooling the refrigerant between stages of the multi-stage compression.

19. The method of claim 16, wherein the industrial application includes at least steam-assisted gravity drainage (SAGD), petrochemical production, or paper production.

20. The method of claim 19, wherein the steam-assisted gravity drainage (SAGD) is used to extract a hydrocarbon fuel.
